(19) United States
(12) Patent Application Publication
(10) Pub. No.: US 2011/0011484 A1
(43) Pub. Date: Jan. 20, 2011

(54) COLD SHRINK ARTICLE

(75) Inventors: Christopher J. Evoniuk, Austin, TX (US); Tony F. Daniel, Austin, TX (US); Thomas E. Umlauf, Austin, TX (US); Kim P. Mulvey, Austin, TX (US); Brent W. Katz, Austin, TX (US); Jeanine I. Zeller-Pendrey, Austin, TX (US); Dennis G. Brannan, Austin, TX (US); Garry L. Sjolander, Austin, TX (US); Melanie G. Gover, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/832,856

(22) Filed: Jul. 8, 2010

Related U.S. Application Data
(60) Provisional application No. 61/225,996, filed on Jul. 16, 2009.

(51) Int. Cl. F16L 9/00; F16L 47/00

(52) U.S. Cl. 138/177; 285/294.1

(57) ABSTRACT

Described herein is an article comprising a cold shrinkable hollow body having at least one open end, and at least a portion of the inner surface of the hollow body having one or more protrusions.

### CROSS REFERENCE To RELATED APPLICATION

This application claims the benefit of U.S. Provisional Patent Application No. 61/225,996, filed Jul. 16, 2009, the disclosure of which is incorporated by reference herein in its entirety.

### TECHNICAL FIELD

This invention relates to cold shrink articles such as end caps and splices.

### BACKGROUND

Cold shrink articles are generally used to seal or otherwise protect an apparatus such as a cable or splice. Some embodiments of existing cold shrink articles operate such that a cold shrinkable material is held in an expanded or stretched state over a support core such as a removable ribbon core. When the support core or ribbon is unwound and removed from supporting the cold shrinkable material, the cold shrinkable material shrinks in diameter and tightly fits onto the outer surface of an apparatus.

### SUMMARY

One embodiment of the present invention features an article comprising a hollow body comprising a cold shrinkable material, the hollow body having at least one open end, and at least a portion of the inner surface of the hollow body having one or more protrusions.

Another embodiment of the present invention features an article comprising a cable end cap having a cold shrinkable hollow body, the hollow body having one open end and one closed end, and at least a portion of the inner surface of the hollow body having one or more protrusions.

Another embodiment of the present invention features an article comprising a cable splice body having a cold shrinkable hollow body, the hollow body having at least two open ends, and at least a portion of the inner surface of the hollow body having one or more protrusions.

An advantage of at least one embodiment of the present invention is that it can be used as both a temporary and permanent end cap.

Another advantage of at least one embodiment of the present invention is that it can accommodate different sized apparatuses.

The above summary of the present invention is not intended to describe each disclosed embodiment or every implementation of the present invention. The Figures and detailed description that follow below more particularly exemplify illustrative embodiments.

### BRIEF DESCRIPTION OF DRAWINGS

FIG. 1 illustrates a cross-section of a cold shrink end cap embodiment of the present invention.

FIG. 2a illustrates the cold shrink end cap embodiment of FIG. 1 with an inserted support core.

FIG. 2b illustrates the cold shrink end cap embodiment of FIG. 1 the open end of the end cap folded back over an external support core.

FIG. 3 illustrates a cross-section of a cold shrink splice embodiment of the present invention.

FIGS. 4a and 4b illustrate cross sections of alternate splice embodiments of the present invention.

FIGS. 5a and 5b illustrate cross-sections of alternate embodiments of the cold shrink articles of the present invention.

FIG. 6 illustrates a cross-section of an alternate embodiment of the cold shrink articles of the present invention.

FIGS. 7a to 7f illustrate cross-sections of alternate embodiments of the cold shrink articles of the present invention.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be used, and structural or logical changes may be made without departing from the scope of the present invention. The following detailed description, therefore, is not to be taken in a limiting sense, and the scope of the invention is defined by the appended claims.

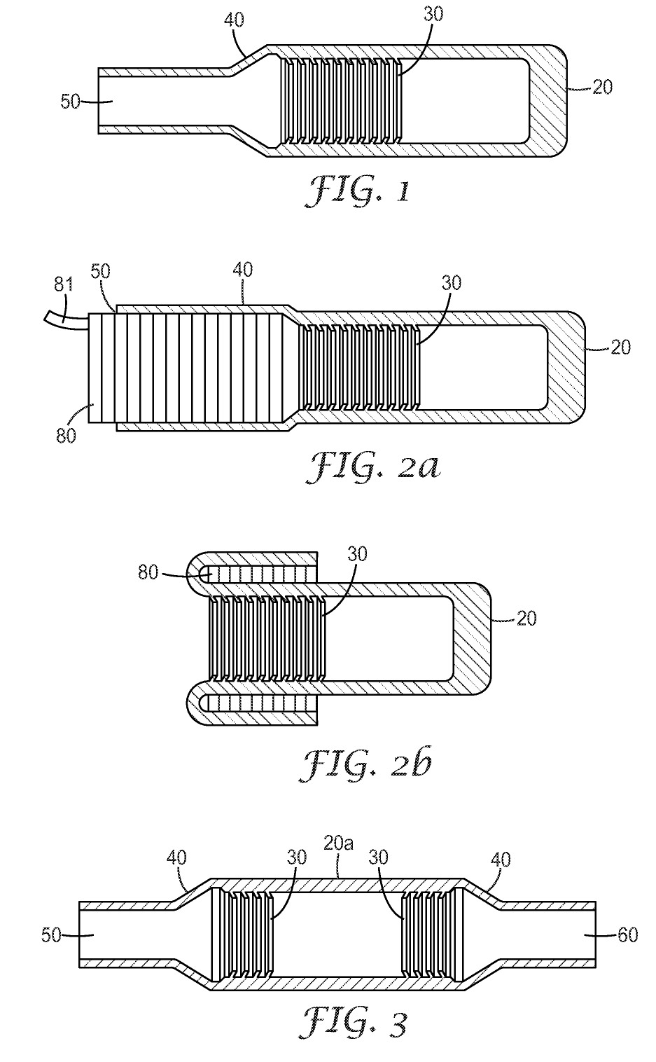

FIG. 1 shows a cross-section of one embodiment of the present invention in which the cold shrinkable hollow body 20 can function as an end cap for an apparatus such as a cable. The hollow body includes an area on its inner surface having protrusion 30. The protrusions 30 are adjacent a tapered section 40 of the hollow body that, in turn, is adjacent to a first open end 50 of the hollow body. In this end cap embodiment of the present invention, there is only one open end.

FIG. 2a shows a cross-section of the embodiment of FIG. 1 with a support core inserted into the hollow body 20 such that it expands the first open end 50 and tapered section 40, but not the protrusions 30. Typically, the support core 80 is adjacent a portion of the hollow body 20 that includes protrusions on its inner surface. As generally illustrated in FIG. 2a, the support core 80 and the hollow body 20 can collectively form a single unit to be applied to an apparatus inserted into hollow body 20. After the support core 80 is removed from the cold shrinkable hollow body 20 by pulling on core remover 81, which initiates the unwinding of support core 80, the contraction of the first open end of the hollow body 20 around the apparatus can provide protection and/or an environmental seal, such as a vapor seal for the portion of the apparatus within the hollow body 20.

FIG. 2b shows an alternate embodiment in which the support core 80 is placed around the hollow body 20 (and sized accordingly) and the first open end of the hollow body is folded back over the support core.

Preferably, the first open end 50 and the protrusions 30, when in a relaxed state before installation of the end cap on an apparatus, have inner diameters that are less than the outer diameter of the support core 80 and that are less than the outer diameter of the portion of the apparatus to which they are to be applied. The inner diameters of the protrusions may be measured along the highest points of the protrusions.

The amount by which the inner diameters of these sections are less than the outer diameters of the support core and apparatus may vary. Preferably, as the end cap is installed on the apparatus, the amount of insertion force needed to move the apparatus past the protrusions is greater than the insertion force required to move the apparatus past other portions of the hollow body. The inner diameters of the other areas of the end cap may be greater than or substantially equal to the portions of the apparatus to which they are to be applied, as understood by those skilled in the art.

The end cap embodiment with the inserted support core 80 can be placed onto an apparatus, such as an electrical cable. Prior to removal of the support core, the end cap can be used as a temporary end cap, i.e., it can be moved on and off the apparatus multiple times. Embodiments of the present invention provide an advantage over other temporary end caps because the protrusions on the interior surface of the hollow body provide a frictional fit that helps keep the end cap on the apparatus until it is desired to be removed. As will be discussed later in more detail, the embodiment of the invention shown in FIG. 1, in which the protrusions are concentric ridges angled toward the interior of the hollow body, provides an additional advantage because the insertion force required to place an apparatus in the end cap is less than the removal force required to take the apparatus out of the end cap. This allows the end cap to be easily placed on the apparatus, but difficult to accidentally dislodge. If the end cap is to be used as a permanent end cap, the support core can be removed after the apparatus is inserted into the hollow body. Subsequently, the end cap would need to be cut off to remove it from the apparatus.

FIG. 3 shows an alternate embodiment of the invention in which the hollow body is a splice body. In this embodiment, there is a second open end 60 opposite first open end 50, a second area having protrusions 30, and a second tapered section 40. A first support core (not shown) can be positioned in and adjacent to the first open end 50 of the hollow body 20a such that it expands the first open end 50 and tapered section 40, but not protrusions 30. A second support core (not shown) can be positioned in and adjacent to the second open end 60 of the hollow body 20a. Each support core holds a portion of the hollow body 20a in an expanded state at least until the support core is removed from the hollow body 20a.

Embodiments of the invention such as those shown in FIG. 3 can include a number of support cores (not shown). Although the splice in FIG. 3 shows a splice for two apparatuses, the invention is suitable for splices that are used on three or more apparatuses, which are known to those of skill in the art.

This type of embodiment of the present invention is typically used to join and hold together two apparatuses, such as two cables. An apparatus can be inserted into each side of the cold shrinkable hollow body 20 through an open end that is held in an expanded state by a support core. One of the support cores can be removed from the cold shrinkable hollow body 20, thereby shrinking and securing the cold shrinkable hollow body 20 around one apparatus. The other support core on the other side of the cold shrinkable hollow body 20 can be removed from the cold shrinkable hollow body 20, thereby shrinking and securing the cold shrinkable hollow body 20 around the other apparatus.

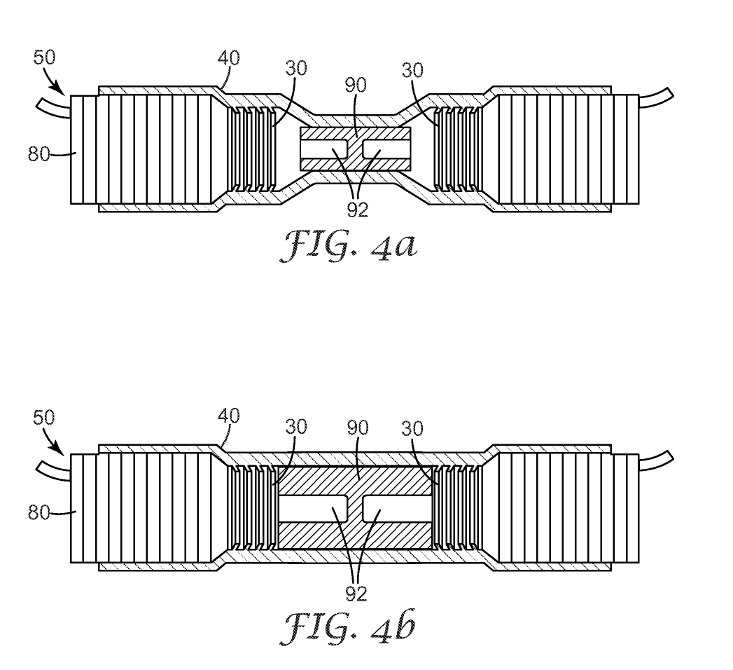

The type of embodiment of the present invention shown in FIG. 3 could be used, for example, with connectors as shown in FIGS. 4a and 4b. FIG. 4a shows a splice embodiment in which the central section of the cold shrink hollow body is contracted around connector 90. In this embodiment, the central section of the hollow body preferably has an inner diameter that is smaller than the outer diameter of connector 90 when the hollow body is in a relaxed state. Connector 90 has two openings 92 for insertion of a portion of the apparatuses being connected, e.g., the conductive cores of a power cable. FIG. 4b shows a splice embodiment in which the central section of the cold shrink hollow body encompasses connector 90. In this embodiment, the central section of the hollow body preferably has an inner diameter that is approximately the same as the outer diameter of connector 90 when the hollow body is in a relaxed state. In this embodiment, the ridges 30 on either side of the connector 90 inhibit significant lateral movement of the connector 90 in the hollow body.

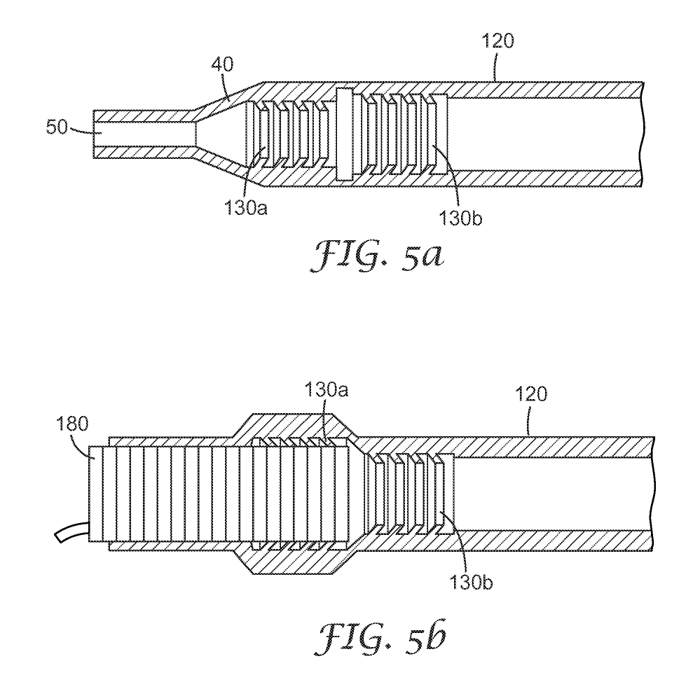

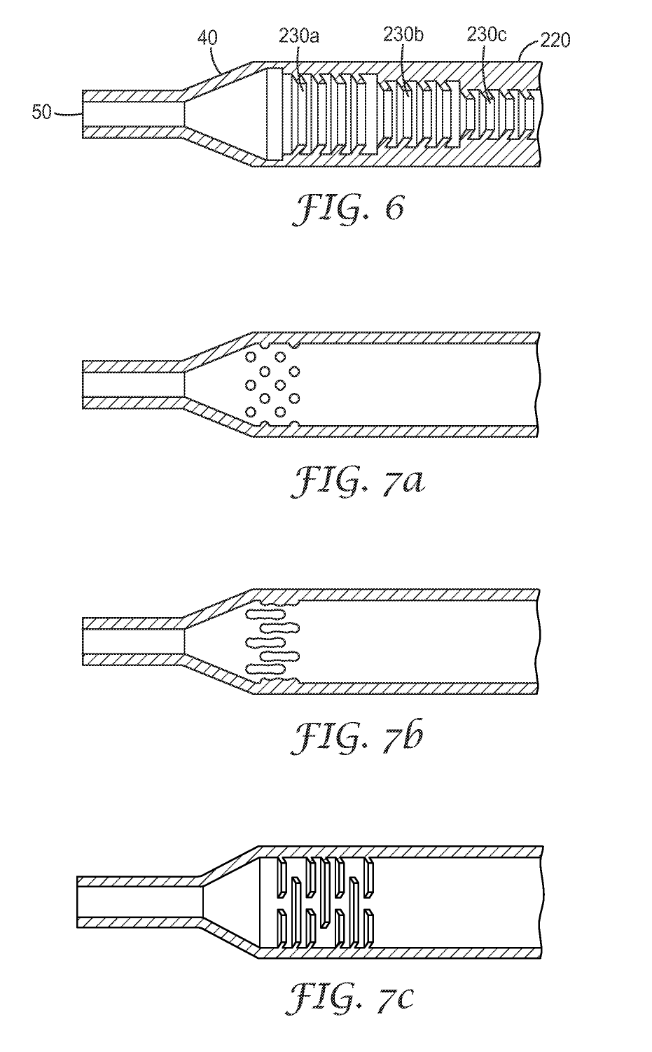

FIGS. 5a, 5b and 6 show alternate embodiments in which multiple regions of protrusions can be used to accommodate different sized apparatuses with a single cold shrink hollow body 120. As shown in FIG. 5a, the hollow body has first and second sets of protrusions, 130a and 130b, respectively. First set of protrusions 130a is closer to the first open end 50 than second set of protrusions 130b and has a smaller inner diameter. If a small diameter apparatus were to be inserted into hollow body 120, a support core such as support core 80, shown in FIG. 2 would be inserted into hollow body 120 to expand the first open end 50 and tapered section 40. Once inserted, the apparatus would be held in place, temporarily by first set of protrusion 130a, and permanently by the contraction of open end 50 around the apparatus once the core 180 is removed. As shown in FIG. 5b, if a large diameter apparatus were to be inserted into hollow body 120, support core 180 would be inserted into hollow body to expand the first open end 50, tapered section 40, and first set of protrusion 130a. Once inserted, the apparatus would be held in place, temporarily by first set of protrusion 130b, and permanently by the contraction of first set of protrusions 130a and open end 50 around the apparatus once the core 180 is removed.

The hollow body 220 of FIG. 6 shows an alternate embodiment having multiple sets of protrusions: first set of protrusions 230a, second set of protrusions 230b, and third set of protrusions 230c. Additional sets of protrusions could be added, depending on the dimensions of hollow body 220 and its intended use. In FIG. 6, first set of protrusions 230a has a larger inner diameter than second set of protrusions 230b, which, in turn, has a larger inner diameter than third set of protrusions 230c. In this embodiment, a support core such as support core 80, shown in FIG. 2 could be inserted into hollow body to expand the first open end 50 and tapered section 40, but would not need to extend further into hollow body 220. If a large diameter apparatus (e.g., an apparatus that would form a friction fit with the first set of protrusions 230a, but be too large to fit into the second set of protrusions 230b) were to be inserted into hollow body 220, it would be inserted to the point at which it butts up against the second set of protrusions 230b.

If a medium diameter apparatus (e.g., an apparatus that would form a friction fit with the second set of protrusions 230b, but be too large to fit into the third set of protrusions 230c) were to be inserted into hollow body 220, it would be inserted to the point at which it butts up against the third set of protrusions 230c. If a small diameter apparatus (e.g., an apparatus that would form a friction fit with the third set of protrusions 230c) were to be inserted into hollow body 220, it would be inserted to a desired depth past the third set of protrusions 230c. Once inserted, the apparatus would be held in place, temporarily by the set of protrusion 230a, 230b, or 230c with which if forms a friction fit, and permanently by the contraction of open end 50 around the apparatus once the support core 80 is removed.

The protrusions may be of any form, shape, size, etc. so long as they create some amount of friction against the apparatus being inserted into the hollow body. The protrusions may vary in pitch, density, flexibility, length, width, angle, etc. Protrusions such as the ridges shown in FIG. 1 may be at a 90° angle with respect to the interior wall of the hollow body. Alternately, they may be angled, typically toward the interior of the hollow body. By angling the ridges toward the interior of the hollow body, the force required to remove an inserted apparatus will be greater than the force required to insert the apparatus because the angled ridges will “grab” the apparatus when it is removed, whereas the apparatus will slide over the angled ridges upon insertion. The angle may be anything less than 90° and tailored to achieve a desired level of insertion and removal force, but will most typically be between 90° and 45°.

The protrusions may be varied in height to accommodate different sized apparatuses. If the protrusions such as the ridges shown in FIG. 1 have a suitable flexibility, they could be made longer to enable the cold shrinkable article to accommodate different sized apparatus. In such an article, a smaller diameter apparatus would cause less deflection of the ridges, while a larger diameter apparatus would cause a greater deflection of the ridges.

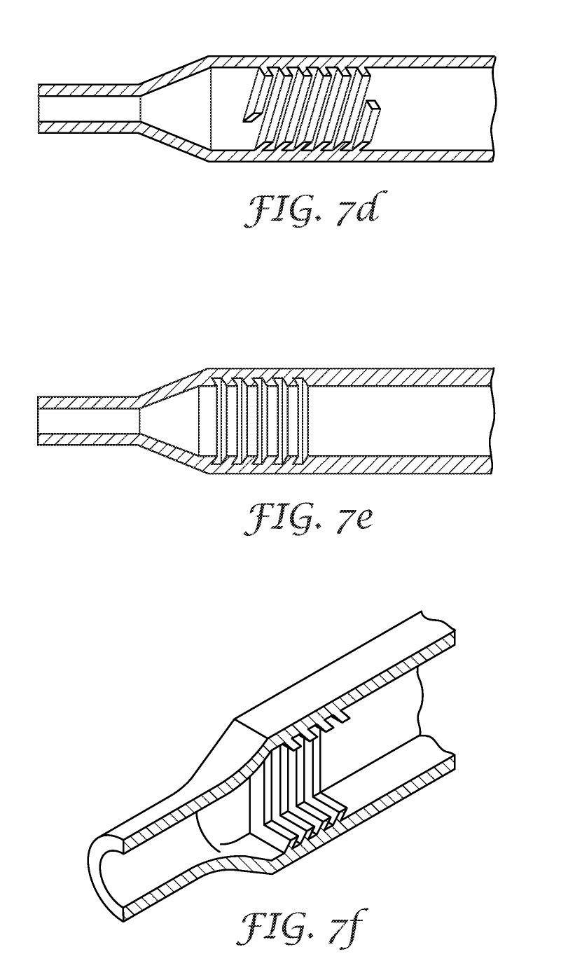

FIGS. 7a to 7e show exemplary embodiments of protrusions suitable for the present invention, but many other embodiments would be suitable. The protrusions shown in 7a are generally hemispheric in shape and random in placement around a portion of the inner wall of the hollow body. The protrusions shown in FIG. 7b are elongated and generally parallel to the longitudinal axis of the hollow body and are of random shapes. The protrusions shown in FIG. 7c are similar to those in FIG. 1, but are discontinuous around the inner circumference of the hollow body. The protrusions shown in FIG. 7d are formed from a single spiral ridge. The protrusions shown in FIG. 7e are formed by making part, or all, of the wall of the hollow body thicker and forming channels in the thickened wall.

The structure of each of the support core and the cold shrinkable hollow body can feature a generally tubular structure in shape. For example, the tubular structure of the support core and the cold shrinkable hollow body can be preferably cylindrical in character, but can have alternative tubular shapes as well. Such alternative tubular shapes can include, but are not limited to, tubular triangular shapes, tubular square shapes, tubular rectangular shapes, tubular pentagonal shapes, tubular hexagonal shapes, tubular octagonal shapes, or other suitable tubular shapes, as understood by those skilled in the art. FIG. 7f illustrates an end cap embodiment of the invention having a square tubular shape.

The cold shrinkable hollow body, as generally understood by persons having ordinary skill in the art, can be any material that can be formed into a hollow body that is capable of being held in an expanded state by a support structure and which shrinks in diameter when the support structure is removed from the cold shrinkable hollow body. For example, the cold shrinkable hollow body can be made from a rubber material, a thermoplastic elastomer, or other suitable material demonstrating cold shrink properties (such as being capable of elongation greater than 100% and permanent set less than 30%), as understood by those skilled in the art. Examples of suitable rubber materials include, but are not limited to, silicone rubber, EPDM (ethylene-propylene-diene copolymer), IR, SBR, CR, IIR, NBR, hydrogenated NBR, acrylic rubber, ethylene acrylic rubber, rubber material having fluoroelastomer fillers, or rubber material having epichlorohydrin fillers. Examples of suitable thermoplastic elastomers include, but are not limited to, plastic materials, olefin thermoplastic elastomers, styrene thermoplastic elastomers such as SBS (styrene-butadiene block copolymers), and SEBS (styrene-ethylene butylene-styrene copolymers). Other suitable elastomeric compositions are those that include one or both of epichlorohydrin and fluoroelastomers such as those described in U.S. Pat No. 7,553,894 and published co-pending applications U.S. 2008-024924 and U.S. 2008/0281032, which are hereby incorporated by reference.

To improve the properties of the cold shrinkable hollow body, various additives, agents, and/or fillers may be included such as, for example, coloring agents, flame retardants, lubricants, processing aides, fillers, softening agents, antistatic agents, crosslinking agents, crosslinking aides in proper amounts. Embodiments of the cold shrinkable hollow body can exhibit desirable characteristics of good tear strength, heat resistance, fluid resistance, hydrocarbon resistant, transparency, and other features as understood by those skilled in the art.

As previously mentioned, the support core can be various shapes and various sizes. Embodiments of the support core can be made from, for example, polymers, plastics, metals, or other suitable materials capable of holding a cold shrinkable hollow body in an expanded state.

The support core can include, for example, a removable support core such as a cylindrical support composed of a spirally wrapped ribbon. A cylindrical removable support core is prepared by integrally forming a plastic ribbon in a spiral shape to provide a cylindrical body. The cylindrical support body may also be formed by another method in which the external surface of a hollow cylinder is spirally severed, grooved, perforated, or otherwise cut. Some embodiments may include adjacent spiral ribbon portions bonded or held in a temporary bonded state at the cut portion. The cylindrical support has sufficient strength to hold a cold shrinkable hollow body in an expanded state. The removable support core including a spirally wrapped ribbon can be unwrapped by successively unfastening one spiral ribbon portion from the next adjacent spiral ribbon portion along spirally formed grooves by manually withdrawing one end of the plastic ribbon. Other suitable support cores include a cylindrical slide-out support that operates as a single unitary member having a low friction surface that can slide out from the cold shrinkable material and a crushable support core.

Examples of an apparatus that may be employed within the cold shrink hollow body include, but are not limited to, connectors, cable ends, lugs, splices, or other suitable devices such as cables and wires for electrical applications, fibers for telecommunications applications, cords, pipes, branched cables, barrier boots, butt splices, conduit joints, secondary distribution connections, buss connections, cable-to-buss connections, pedestal connections, 3-core cables, coax cables, coax connectors, bolts, hardware, kerneys, irrigation components, pin and sleeve components, and any other form of apparatus that may need sealing from cold shrink.

In addition to the foregoing embodiments, other embodiments of the invention include the use of an encapsulant in conjunction with the protrusions. The encapsulant is not a required feature, but rather an optional feature that can be utilized when desired. The encapsulant can be coated on and around the protrusions. For example, if the protrusions are ridges, the encapsulant can be loaded into the troughs between the ridges and can form a vapor and water seal between the atmosphere and the interior of the hollow body once the apparatus is inserted into the hollow body. Alternatively, encapsulant can be loaded in the interior of the hollow body and the protrusions can be used to prevent leakage of the encapsulant once the apparatus is inserted into the hollow body. The encapsulant can include curable composition or curable systems, or alternatively mastics, greases or gels that do not require curing.

Examples of curable composition or curable systems can include thermal curable or thermoset encapsulants, radiation curable encapsulants, water curable encapsulants, or other types of curable encapsulants. Thermal curable or thermoset encapsulants can include resin compositions such as epoxy, polyurethane, polyester, acrylate, or other types of resins that demonstrate a degree of hardness after curing or setting. Other curable compositions can include embodiments of curable gels that are in liquid form during injection or installation, whereby curing takes place after the curable gel is injected or installed within the tubular portions of the article. Curable gel compositions can be capable of making a physical transformation from a liquid to a rubbery gel semi-solid that the user can cure to form a rubber hydrophobic gel sealant. In addition, some curable compositions can provide moisture protection which may offer advantages in particular applications.

Mastics that are suitable for use as encapsulants in the present invention include flowable materials, including insulative mastics such as polyisobutylene, ethylene propylene rubber, butyl rubber, or other materials such as caulk, silicone grease, cured or uncured elastomers having processing oils or rubber modifiers, liquid elastomers, plasticizers, or modified plastisols. Other suitable mastics include epihalohydrin and silicone polymers blends which may additionally include fillers such as barium titanate, hydrated aluminum, and a plasticizer such as those described in U.S. Pat. No. 5,962,569.

Alternatively, the encapsulant can include gel compositions that do not require curing. For example, the encapsulant can be a pre-formed soft oil-filled rubber hydrophobic gel sealant. Embodiments of this soft oil-filled rubber hydrophobic gel sealant can include, for example, at least a polymer and an oil portion, such as a polymeric hydrophobic rubber gel sealant including at least a portion of oil. Examples of polymers that are useful can include oil-filled silicones, polyurethanes, polyesters, polyepoxys, polyacrylates, polyolefins, polysiloxanes, polybutadienes (including polyisoprenes), and hydrogenated polybutadienes and polyisoprenes, as well as copolymers, including block copolymers and graft copolymers.

As another alternative, the encapsulant can include grease compositions that do not require curing. The grease composition can include, for example, a thickener cooperating with at least a portion of oil. The grease composition can provide the properties of low shear yield point and higher adhesion than cohesion. The thickener can include, for example, an organic polymeric composition. The organic polymeric composition can include, for example, polymers including polyurethanes, polyesters, polyepoxys, polyacrylates, polyolefins, polysiloxanes, polybutadienes (including polyisoprenes) and hydrogenated polybutadienes and polyisoprenes, as well as block copolymers. The blocks of the block copolymers can include, for example, the above polymers and poly(monoalkenylarenes) including polystyrene. These bock copolymers can include particularly SEB (Styrene, ethylene-butylene), SEP (Styrene, ethylene-propylene), SEBS (Styrene, ethylene-butylene, Styrene), SEPS (Styrene, ethylene-propylene, Styrene), similar Styrene-rubber polymers, di-block, graft- and star-block copolymers, and block copolymers with blocks which are non-homogeneous. Alternatively, for example, the thickener can include an inorganic sol composition. The inorganic sol composition can include, for example, alumina, silica, or clay. Alternatively, for example, the thickener can include a soap composition. The soap composition can include, for example, metal complex soaps, aluminum complex soaps, lithium complex soaps, or calcium complex soaps.

Also, for example, the thickener can be other types of greases, waxes (including polyethylene and polypropylene waxes), or viscoelastic polymeric hydrophobic compositions including at least a portion of oil.

All various types of embodiments of the article can be used in various industries and in various applications. Embodiments can be utilized, for example, in the electrical industry for protecting cables or other apparatus, telecommunications industry for protecting fibers or other apparatus, automotive industry, irrigation industry, mining industry, utilities industry, energy industry, construction industry, and any other industry that may benefit from the increased protection provided by the protective core and the cold shrinkable material. Applications of the article can include utilization for rejacketing a cable or series of cables, terminating a cable or series of cables, grounding connections, antenna connections, industrial pin and sleeve connections. Exemplary applications can include, but are not limited to, branch applications, resin applications, barrier boot applications, mining cable splice applications, conduit joint seal applications, floodseal applications, end cap sealing applications, cellular tower applications including cellular tower grounding connector sealing applications and/or cellular tower splice applications, electrical box applications, insulating hardware including lugs/bolts, kerney applications, pedestal connection applications, irrigation applications, lighting applications such as airport lighting and/or street lighting, as well as many other applications for which the article is suitable.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof

What is claimed is:

1. An article comprising:
A hollow body comprising a cold shrinkable material,
the hollow body having at least one open end, and
at least a portion of the inner surface of the hollow body having one or more protrusions.

2. The article of claim 1 wherein one end of the hollow body is open and one end of the hollow body is closed.

3. The article of claim 1 wherein the one or more protrusions are substantially perpendicular to the longitudinal axis of the hollow body.

4. The article of claim 1 wherein at least one of the protrusions is discontinuous.

5. The article of claim 1 further comprising two sets of protrusions wherein one set of protrusions projects further into the interior of the hollow body than the other set.

6. The article of claim 1 wherein the protrusion shape is selected from the group consisting of ridges, hemispheres, spirals, and random shapes.

7. The article of claim 1 wherein the one or more protrusions project at an angle of about 90 degrees to about 45 degrees from the inner surface of the hollow body.

8. The article of claim 7 wherein the outer edge of the one or more protrusions points away from an open end of the hollow body.

9. The article of claim 1 wherein the circumference of the hollow body near the open end is smaller than the circumference of the remainder of the hollow body, the hollow body includes a section having a tapered circumference between the open end and the remainder of the hollow body, and the protrusions on the inner surface of the hollow body are adjacent and interior to the portion of the hollow body having a tapered circumference.

10. The article of claim 1 wherein the portion of the hollow body adjacent the open end is held in an expanded state by a support core.

11. The article of claim 1 comprising:
a cable end cap having a cold shrinkable hollow body, the hollow body having one open end and one closed end.

12. The article of claim 11 wherein the one or more protrusions are perpendicular to the longitudinal axis of the hollow body.

13. The article of claim 11 wherein the inner diameters of the one or more protrusions are configured to be smaller than the outer diameter of the cable to be inserted into the end cap.

14. The article of claim 13 wherein inner diameter of the portion of the hollow body interior to the protrusions is equal to or greater than the outer diameter of the cable to be inserted into the end cap.

15. The article of claim 11 wherein there are multiple protrusions extending continuously around the circumference of the inner surface of the hollow body and an encapsulant is located between at least two protrusions.

16. The article of claim 11 wherein the one or more protrusions project at an angle of about 90 degrees to about 45 degrees from the inner surface of the body and the outer edge of the one or more protrusions points away from the open end of the hollow body.

17. The article of claim 14 further comprising a cable wherein the force required to insert the cable into the end cap is equal to or greater than the force required to remove the cable from the end cap.

18. The article of claim 14 further comprising a cable inserted into the end cap wherein the cable and protrusions form an environmental seal between the inner portion of the hollow body interior to the protrusions and the portion of the body exterior to the protrusions.

19. The article of claim 11 wherein the cold shrinkable hollow body comprises hydrocarbon-resistant material.

20. The article of claim 1 comprising:
a cable splice body having a cold shrinkable hollow body, the hollow body having at least two open end.
